(19) United States
(12) Patent Application Publication
(10) Pub. No.: US 2009/0211462 A1
(43) Pub. Date: Aug. 27, 2009

(54) Peeler and Slicer Apparatus

(75) Inventor: Geoffrey Foxcroft, East Keilor (AU)

Correspondence Address: Ballard Spahr Andrews & Ingersoll, LLP, SUITE 1000, 999 PEACHTREE STREET, ATLANTA, GA, 30309-3915, US

(73) Assignee: Viapak Pty Ltd., Park Orchards (AU)

(21) Appl. No.: 11/884,331

(22) PCT Filed: Feb. 10, 2006
(86) PCT No.: PCT/AU06/00182

§ 371 Date: Mar. 13, 2009

(30) Foreign Application Priority Data
Feb. 15, 2005 (AU) 2005900706

(51) Int. Cl. A23N 4/12

(52) U.S. Cl. 99/543

(57) ABSTRACT

A peeling and slicing apparatus is disclosed which comprises a corer consisting of a cutting cylinder, a peel removing ring and a plunger. The cylinder is forced into a piece of fruit to produce a core and the ring moves relative to the cylinder to separate the peel from the core. The plunger then moves into the cylinder to push the core from the cylinder. A holder is provided for receiving the core. The holder has first and second components which are moveable relative to one another so that the core is clamped in the holder and may be released from the holder after the core has been sliced. The holder has a plurality of fingers which are spaced apart so that slicing blades can enter the spaces between the fingers to slice the core. The cylinder may have segmenting blades and may be mounted for rotation about its axis to facilitate cutting into the fruit.

### FIELD OF THE INVENTION

This invention relates to a peeler and slicer apparatus and relates particularly, but not exclusively, to a peeler and slicer for citrus fruit such as oranges.

### DESCRIPTION OF PRIOR ART

Hitherto citrus fruits such as oranges have been peeled in commercial quantities either manually or by a rotating disc cutter which described a helix cut to the skin so a skin removing member can pass under the skin and remove the skin as an elongate spiral. The above are laborious or time consuming. Both are expensive.

Our U.S. Pat. No. 5,105,734, the contents of which are incorporated into this specification by this reference, discloses a peeler which overcomes the above-mentioned problems. However, the peeler according to that US patent does still involve a number of rejects which are formed during the slicing operation.

### OBJECT AND STATEMENT OF THE INVENTION

The object of a first aspect of the present invention is to decrease the number of rejects which are formed by a machine of the type described in the above US patent.

The present invention provides a peeler and slicer apparatus for slicing an article, comprising:
a corer for receiving the article and for cutting a core from the article to thereby remove a peripheral layer of peel from about the article;
a holder having a first component and a second component which are relatively moveable into a clamping position so the core is clampable in the holder, and a release position so that the core is releasable from the holder, the holder having a plurality of spaces; and
a slicer having a plurality of slicing blades for entering the spaces and slicing the core to thereby slice the article into a plurality of sliced pieces when the holder is in the clamping position.

Since the article is held firmly by the holder in the clamping position when the article is sliced, the amount of rejects are greatly reduced because of the lack of relative movement between the holder and the core and therefore much better sliced pieces of article are provided.

In one embodiment the first component of the holder comprises a plurality of spaced apart fingers, the second component comprising a plurality of spaced apart fingers which register with the spaced apart fingers of the first component, a hinge for coupling the first component to the second component, and a spring for biasing the first component into a clamping position relative to the second component.

Preferably the second component comprises an abutment and the apparatus includes a cam so that after the article has been sliced, the abutment engages the cam to force the first component away from the second component against the bias of the spring to thereby release the sliced article from the holder.

Preferably the corer comprises a cutting member, a movable member arranged for relative movement into said cutting member and a peel removing member, wherein said cutting member is adapted to cut into an article to be peeled so that at least a portion of said article is received within said cutting member with the peel surrounding the cutting member, said peel removing member is adapted to move relative to said cutting member to push the peel away from the cutting member and said movable member being movable relative to said cutting member into said cutting member so that said portion of the article can be pushed out of said cutting member.

Preferably said cutting member comprises a cylinder and said movable member comprises a plunger arranged within a top portion of said cylinder and movable relative to said cylinder so as to push said portion of the article out of said cylinder after it is cut.

Preferably said peel removing member comprises a ring member which surrounds the cutting cylinder and is movable relative to the cutting cylinder so as to push the peel away from the cutting cylinder.

In another embodiment, the first component of the holder comprises a plurality of spaced apart fingers, the second component comprises a plurality of spaced apart fingers which register with the spaced apart fingers of the first component, a first pivot pin for pivotally coupling the first component for pivotal movement relative to the second component, and the apparatus further comprising a mechanism for positively forcing the first component and second component into the clamping position and for positively moving the first component relative to the second component to the release position.

Preferably the mechanism comprises a cam track for engaging an abutment on one of the first and second components for pivoting the first component relative to the second component into the clamping position, and a second cam component for engaging the abutment to pivot the second component relative to the first component so that the first component and second component are moved to the release position.

In this embodiment the holder has a second pivot pin for pivotally coupling the first component relative to the device and the second component includes a cam surface so when the first and second components move about the first pivot pin, the cam surface of the second component engages the first component to cause pivotal movement of the second component about the second pivot pin to facilitate opening of the holder into the release position.

In one embodiment of the invention the corer includes a rotating mechanism for rotating the corer as the corer cuts the article to facilitate cutting of the article by the corer.

In one embodiment the mechanism may comprise a worm drive for engaging a cooperating track on the corer for rotating the corer.

In a still further embodiment the corer has a plurality of internal segmenting blades so that when the corer cuts a core from the article, the core is also cut into a plurality of segments.

In this embodiment the moveable member comprises a plurality of separated segments for moving over the slicing blades when the moveable member moves relative to the corer to enable the moveable member to move into the corer to push the core from the corer.

The invention also provides a peeler and slicing apparatus comprising a cutting member, a movable member arranged for relative movement into said cutting member and a peel removing member, wherein said cutting member is adapted to cut into an article to be peeled so that at least a portion of said article is received within said cutting member with the peel surrounding the cutting member, said peel removing member is adapted to move relative to said cutting member to push the peel away from the cutting member and said movable member being movable relative to said cutting member into said cutting member so that said portion of the article can be pushed out of said cutting member, said cutting member comprising a cylinder and said movable member comprising a plunger arranged to relatively move within a portion of said cylinder to push said portion of the article out of said cylinder after it is cut, and wherein there is provided a pair of discs axially mounted on an axle in spaced apart relation, the spacing being sufficient to allow an article to be peeled to be placed therebetween, article holding means between the discs for supporting the article to be peeled relative to the pair of discs; openings in said pair of discs angularly aligned with each other at the position of said article holding means, said cutting member and said movable member being alignable with said openings, the opening in one of said pair of discs being of a size sufficient to allow both said cutting member and said movable member to pass therethrough, and the opening in the other of said pair of discs being of size to allow the portion of said article to pass therethrough, said pair of discs being axially rotatable with said axle so that when an article is received in said article holding means, said cutting member can extend to pass through the opening in said one of said pairs of discs so said portion will be within said cutting member and said movable member can then extend to pass through said opening to push said portion through the opening in the other of said pairs of discs, and a gripping and holding mechanism having a first component and a second component, each component having a plurality of spaced apart fingers, the first and second components being mounted for relative movement with respect to one another from a clamping position to an open position, so that the portion can be held in the holding and clamping mechanism in a clamped position, and slicing means for slicing the portion through the spaces between the fingers so as to slice the portion into a plurality of sections.

Preferably said peel removing member comprises a ring member which surrounds the cutting cylinder and is movable relative to the cutting cylinder so as to push the peel away from the cutting cylinder.

Preferably there is also provided peel removing means for removing the peel from the ends of said portion of the article.

Preferably said cutting member and said movable member are mounted to said one of said pairs of discs so they rotate with said pairs of discs and wherein said cutting member and said movable member are connected with cam means to effect extension and retraction relative to said pairs of discs so said portion can be cut and received within said cutting member and so said portion can be pushed from said cutting member as the pair of discs rotate and so said cutting member and said movable member can be retracted to allow removal of peel cut from said article and to allow the introduction of another article to said holding means.

Preferably said cam means is mounted co-axially of said axle so that as said pair of discs rotate there will be relative angular movement relative to said cam means whereby said cutting member and said movable member can be extended and retracted.

Preferably there are two cam tracks forming part of said cam means, one track being for a cam follower which connects with said cutting member and the other track being for a cam follower which connects with said pushing member.

Preferably there are a plurality of angularly spaced cutting members and related movable members mounted relative to said pair of spaced discs, each similarly adapted, in turn, to effect peeling of a respective article as said pair of spaced discs is rotated.

Preferably said holding means is movable to clampingly engage with an article during peeling.

Preferably said holding means comprises a pair of swinging arms which can swing to open and close the holding means to release and to hold an article therein, and further cam means to effect such opening and closing as said pair of discs rotate.

Preferably said peel removing means is mounted to swing from a cutting position to permit ease of cleaning of said peeler.

Preferably there is provided article delivery means for delivering an article to said holding means as said holding means rotates therepast.

Preferably the peeler includes a discharge conveyor for receiving peeled articles as they are discharged from said further holding means as said further moulding means rotates therepast.

Preferably the peeler includes peel receiving means for receiving peel cut from said article as said pair of discs is rotated.

Preferably said cutting members and said movable members are attached to said pair of discs by quick release means so they can be changed to different sizes to effect efficient peeling of different sized articles.

In one embodiment the first and second components are mounted by a pivot pin and a biasing means for spring biasing the first and second components into the clamping position.

In another embodiment, the first component of the holder comprises a plurality of spaced apart fingers, the second component comprises a plurality of spaced apart fingers which register with the spaced apart fingers of the first component, a first pivot pin for pivotally mounting the first component relative to the second component, and the apparatus further comprising a mechanism for positively forcing the first component and second component into the clamping position and for then positively moving the first component relative to the second component to the release position.

Preferably the mechanism comprises a cam track for engaging an abutment on one of the first and second components for pivoting the first component relative to the second component into the clamping position, and a cam component for engaging the abutment to pivot the second component relative to the first component so that the first component and second component are moved to the release position.

In this embodiment the holder has a second pivot pin for pivotally coupling the first component relative to the device and the second component includes a cam surface so when the first and second components move about the first pivot pin, the cam surface of the second component engages the first component to cause pivotal movement of the second component about the second pivot pin to facilitate opening of the holder into the release position.

In one embodiment of the invention the corer includes a rotating mechanism for rotating the corer as the corer cuts the article to facilitate cutting of the article by the corer.

In one embodiment the mechanism may comprise a worm drive for engaging a cooperating track on the corer for rotating the corer.

In a still further embodiment the corer has a plurality of internal segmenting blades so that when the corer cuts a core from the article, the core is also cut into a plurality of segments.

In this embodiment the moveable member comprises a plurality of separated segments for moving over the slicing blades when the moveable member moves relative to the corer to enable the moveable member to move into the corer to push the core from the corer.

An object of a second aspect of the invention is to provide an alternative manner of cutting and slicing the article. This aspect has particular application to citrus fruit in the form of mandarins but can nevertheless relate to articles of any type.

This aspect of the invention provides a peeler and slicer apparatus for slicing an article, comprising:
a corer having a peripheral cutting edge and at least one internal cutting blade;
a holder for holding the article;
a moving mechanism for moving the corer relative to the holder so that the peripheral cutting edge cuts a core from the article to thereby remove a peripheral layer of peel from about the article and the internal cutting blade cuts the core into at least two segments; and
a push member for movement relative to the corer for pushing the core from the corer.

This aspect of the invention therefore produces a sliced article in the form of a segmented core somewhat in the nature of a segmented mandarin.

Preferably the apparatus further comprises a slicer having a plurality of slicing blades, the holder having a plurality of spaces, and the slicer being moveable relative to the holder so that the slicing blades are able to enter the spaces and slice the core to thereby slice the segmented core into a plurality of sliced and segmented pieces.

In one embodiment the holder has a first component and a second component, the first component of the holder comprises a plurality of spaced apart fingers, the second component comprising a plurality of spaced apart fingers which register with the spaced apart fingers of the first component, a hinge for coupling the first component to the second component, and a spring for biasing the first component into a clamping position relative to the second component.

Preferably the second component comprises an abutment and the apparatus includes a cam so that after the article has been sliced, the abutment engages the cam to force the first component away from the second component against the bias of the spring to thereby release the sliced article from the holder.

In another embodiment, the holder has a first component and a second component, the first component of the holder comprises a plurality of spaced apart fingers, the second component comprises a plurality of spaced apart fingers which register with the spaced apart fingers of the first component, a first pivot pin for pivotally mounting the first component relative to the second component, and the apparatus further comprising a mechanism for positively forcing the first component and second component into the clamping position and then for positively moving the first component relative to the second component to the release position.

Preferably the mechanism comprises a cam track for engaging an abutment on one of the first and second components for pivoting the first component relative to the second component into the clamping position, and a cam component for engaging the abutment to pivot the second component relative to the first component so that the first component and second component are moved to the release position.

In this embodiment the holder has a second pivot pin for pivotally coupling the first component relative to the device and the second component includes a cam surface so when the first and second components move about the first pivot pin, the cam surface of the second component engages the first component to cause pivotal movement of the second component about the second pivot pin to facilitate opening of the holder into the release position.

In one embodiment of the invention the corer includes a rotating mechanism for rotating the corer as the corer cuts the article to facilitate cutting of the article by the corer.

In one embodiment the mechanism may comprise a worm drive for engaging a cooperating track on the corer for rotating the corer.

In this embodiment the apparatus has a moveable member having a plurality of separated segments for moving over the slicing blades when the moveable member moves relative to the corer to enable the moveable member to move into the corer to push the core from the corer.

The object of a still further aspect of the invention is to improve the manner in which the slicing operation of a peeler and slicer takes place.

This aspect of the invention provides a peeler and slicer apparatus for slicing an article, comprising:
a corer for receiving the article and for cutting a core from the article to thereby remove a peripheral layer of peel from about the article;
a holder for holding the article;
a moving mechanism for moving the corer relative to the holder; and
a core rotating member for rotating the core so that as the corer cuts into the article, rotation of the corer facilitates the cutting action to remove the peripheral layer of peel and produce the core from the article.

The rotation of the corer improves the cutting action and maintains the cutting edge on the corer so the cutting edge does not tend to become blunt.

Preferably the holder has a plurality of spaces and the apparatus further comprises a slicer having a plurality of slicing blades for entering the spaces and slicing the core to thereby slice the article into a plurality of sliced pieces.

Preferably the holder has a first component and a second component which are relatively moveable into a clamping position so the core is clamped in the holder and a release position so the core is releasable from the holder.

In one embodiment the first component of the holder comprises a plurality of spaced apart fingers, the second component comprising a plurality of spaced apart fingers which register with the spaced apart fingers of the first component, a hinge for coupling the first component to the second component, and a spring for biasing the first component into a clamping position relative to the second component.

Preferably the second component comprises an abutment and the apparatus includes a cam so that after the article has been sliced, the abutment engages the cam to force the first component away from the second component against the bias of the spring to thereby release the sliced article from the holder.

In another embodiment, the first component of the holder comprises a plurality of spaced apart fingers, the second component comprises a plurality of spaced apart fingers which register with the spaced apart fingers of the first component, a first pivot pin for pivotally coupling the first component to the second component, and the apparatus further comprising a mechanism for positively forcing the first component and second component into the clamping position and then for positively moving the first component relative to the second component to the release position.

Preferably the mechanism comprises a cam track for engaging an abutment on one of the first and second components for pivoting the first component relative to the second component into the clamping position, and a cam component for engaging the abutment to pivot the second component relative to the first component so that the first component and second component are moved to the release position.

In this embodiment the holder has a second pivot pin for pivotally coupling the first component relative to the device and the second component includes a cam surface so when the first and second components move about the first pivot pin, the cam surface of the second component engages the first component to cause pivotal movement of the second component about the second pivot pin to facilitate opening of the holder into the release position.

In one embodiment the member may comprise a worm drive for engaging a cooperating track on the corer for rotating the corer.

In a still further embodiment the corer has a plurality of internal segmenting blades so that when the corer cuts a core from the article, the core is also cut into a plurality of segments.

In this embodiment the moveable member comprises a plurality of separated segments for moving over the slicing blades when the moveable member moves relative to the corer to enable the moveable member to move into the corer to push the core from the corer.

### BRIEF DESCRIPTION OF DRAWINGS

Examples of preferred embodiments of the invention will be described with reference to the accompanying drawings, in which:

FIG. 1 is a schematic perspective view of the peeler of the above US patent;

FIG. 2 is a view of the peeler of FIG. 1 in a second position;

FIG. 3 is a view of the peeler of FIG. 1 in a third position;

FIG. 4 is a view of the peeler of FIG. 1 in a fourth position;

FIGS. 5 to 8 are cross-sectional views of the peeler which correspond to FIGS. 1 to 4 respectively;

FIG. 9 is an isometric view of a second embodiment of a peeler of the above US patent;

FIG. 10 is a side elevational view of the peeler shown in FIG. 9;

FIG. 11 is an end elevation of the peeler shown in FIG. 9;

FIG. 12 is a plan view of the peeler shown in FIG. 9;

FIG. 13 is an end elevation similar to FIG. 11 but of the preferred embodiment of the present invention;

FIG. 14 is an end view of a gripping device according to the preferred embodiment;

FIG. 15 is a side view of the device of FIG. 14;

FIG. 16 is a side view of one of the components of the device of FIG. 14;

FIG. 17 is a front view of the component of FIG. 6;

FIG. 18 is a side view of the other component of the device of FIG. 14;

FIG. 19 is a front view of the component of FIG. 18;

FIG. 20 is a front view of a corer and moveable member according to a second embodiment of the invention;

FIG. 21 is a front view of the corer;

FIG. 22 is a cross-sectional view along the line XXII-XXII of FIG. 21;

FIG. 23 is a front view of the push member of FIG. 20;

FIG. 24 is a cross-sectional view of the push member along the line XXIV-XXIV of FIG. 23;

FIG. 25 is a front view of a holder according to a second embodiment of the invention;

FIG. 26 is a side view of the holder of FIG. 25;

FIG. 27 is a schematic view of a cam arrangement used in the embodiment of FIGS. 25 and 26;

FIG. 28 is a schematic view of a mechanism for rotating the corer according to a further embodiment of the invention; and

FIG. 29 is a side view of the mechanism of FIG. 28.

### DETAILED DESCRIPTION OF PREFERRED EMBODIMENTS

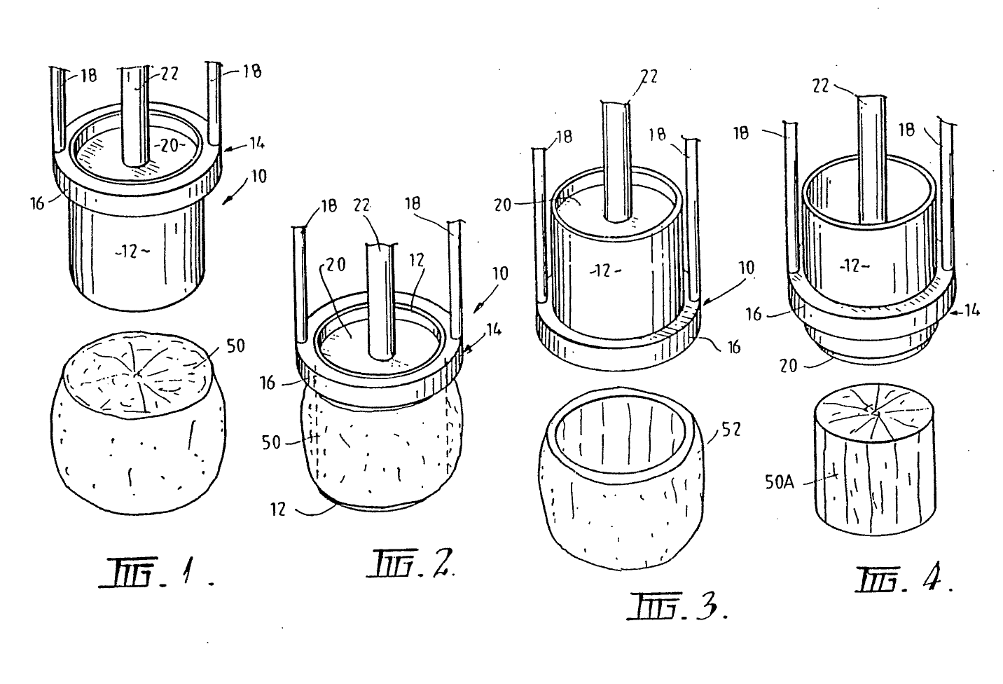

With reference to FIGS. 1 to 8 of the drawings, the peeler 10 of the aforesaid US patent comprises a cylindrical cutting member 12, a peel removing member 14 which comprises a ring 16 which surrounds the cutting cylinder 12 and a pair of upright members 18 connected to the ring 16 for moving said ring 16 relative to said cylinder 12.

In alternative embodiments it would be possible for the peel removing member 14 to comprise a cylinder which is larger than the cylinder 12 and which surrounds the cylinder 12 instead of merely comprising a ring 16 with uprights 18.

A plunger 20 is arranged within the top portion of the cutting cylinder 12 and has a stem 22 for moving said plunger 20 within the cylinder 12.

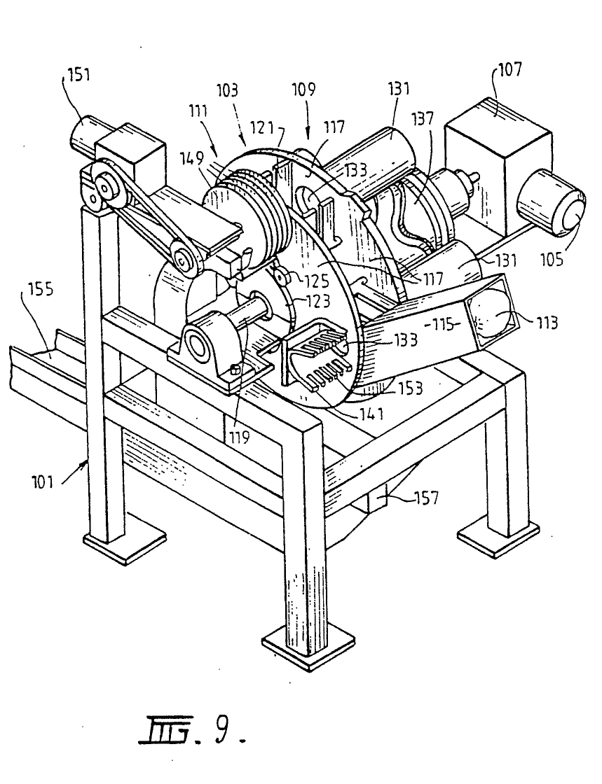

Before an article, such as an orange 50, is peeled it is preferred in this embodiment that the top and bottom of the orange be sliced from the orange as is shown in FIGS. 1 and 5 by suitable peel removing means. In order to peel the orange the entire assembly shown in FIGS. 1 and 5 is moved relative to the orange so that the cutting cylinder 12 cuts into the orange so that the major portion of the orange is contained within the cutting cylinder 12. The skin and possibly some of the outermost portion of the orange adjacent the peel is therefore left outside the cutting cylinder 12 and surrounds the cutting cylinder 12 as is shown in FIGS. 2 and 6.

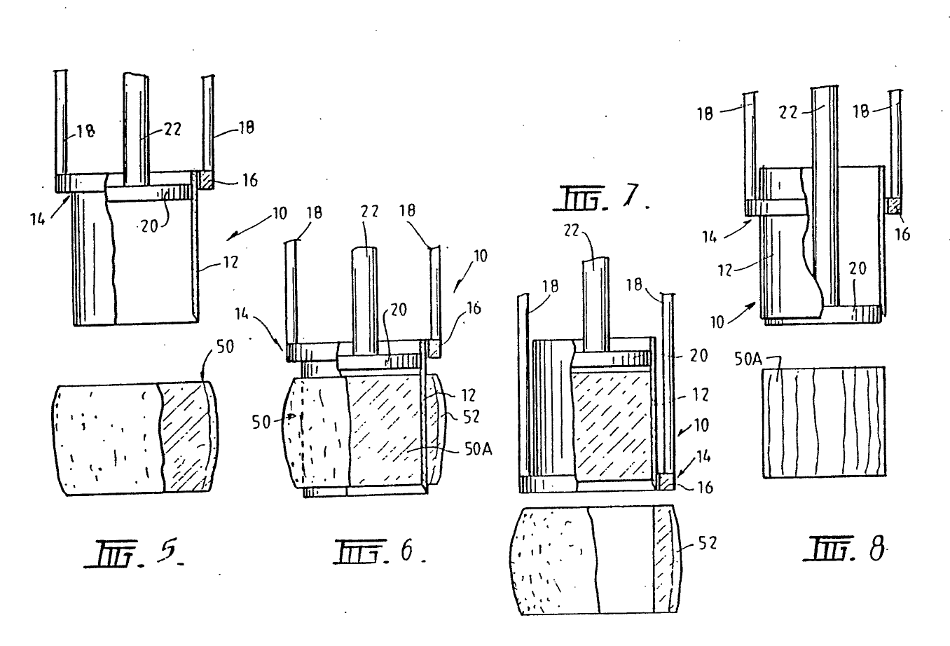

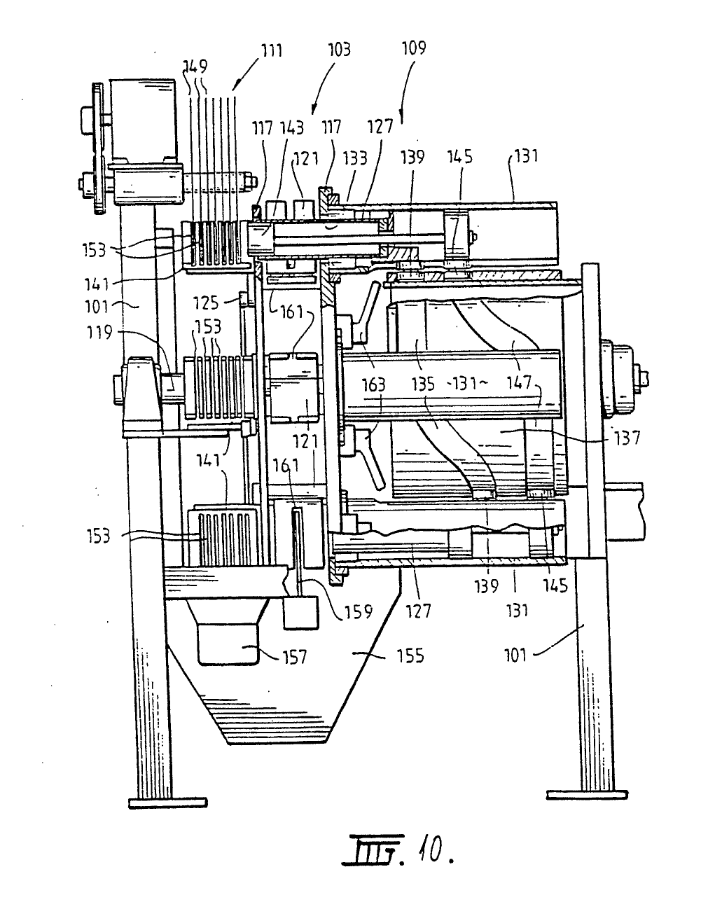

In order to remove the peel 12, the peel remover 14 is actuated, as shown in FIGS. 3 and 7, so that the ring 16 moves downwardly relative to the cylinder 12 so that the skin 52 is pushed off the cylinder 12. Actuation of the peeler 14 can take place by a suitable mechanism which is coupled to the uprights 18.

In order to remove the peeled orange from the peeler, the plunger 20 is moved downwardly within the cylinder 12 relative to the cylinder 12 so that the portion 50A of the orange contained within the cylinder 12 is pushed out of the cylinder 12 as is best shown in FIGS. 4 and 8. The plunger 20 may be moved by a suitable mechanism coupled to the stem 22.

The peeled orange may then be further processed such as by cutting the orange into slices and freezing the slices so that the orange may be transported or offered as a delicacy.

In the preferred embodiment of the invention a machine is proposed which will include a number of the peelers shown in the drawings. The oranges can be cut by a suitable cutting device to remove the top and bottom surfaces and then conveyed to the machine on a conveyor belt. The machine may be indexed so that when the oranges are located beneath the peelers, the peelers are operated to peel a number of oranges in a single cycle of the machine.

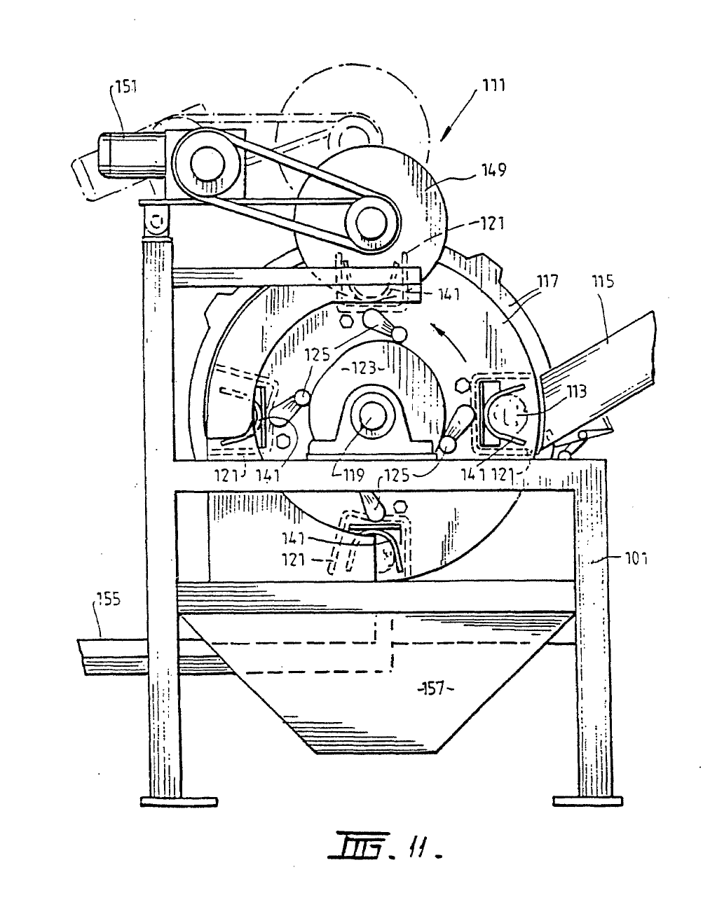

FIGS. 9 through 12 show a frame 101 which carries a peeling and slicing mechanism shown generally by numeral 103. The mechanism 103 is driven from a motor 105 through a right-angled gear box 107. The peeling and slicing mechanism comprises two separate parts. The first part comprises a peeling mechanism 109 and the second part comprises a slicing mechanism 111 forming a peel removing means. Articles 113 to be peeled such as oranges and/or grapefruit or other similar articles 113 are supplied to the peeling mechanism 109 through an inclined chute 115. The articles 113 can be fed to the chute 115 through a suitable hopper means (not shown).

The peeling mechanism 109 includes two spaced apart discs 117 which are mounted in spaced relation along an axle 119. The spacing apart of the discs 117 is approximately equal to the diameter of the largest article to be peeled, i.e. the diameter of the largest expected orange or other product which is to peeled. The spaced apart discs 117 carry U-shaped article holding means 121. The article holding means 121 are spaced with the open end towards the radially outermost edges of the discs 117. The holding means 121 are spaced 90.degree. from each other around the discs 117. Accordingly, there are four holding means 121 provided between the discs 117. The discs 117 are, in turn, attached to the axle 119 and are rotated in an anti-clockwise direction when viewing FIG. 9. Thus, articles 113 can be delivered into the article holding means 121 as the discs 117 rotate to a position at the bottom end of the chute 115. This, in turn, allows the articles 113, such as oranges, to transfer one at a time into each of the article holding means 121.

The arms of the U-shaped article holding means 121 are mounted for swinging movement so that as an article 113 such as an orange is received therein, the arms can swing to clampingly engage with the article 113. This is not clearly shown in the drawings, but FIG. 11 shows the nature of the swinging. This is shown by the dotted lines in relation to the U-shaped article holding means 121. FIG. 11 shows a cam member 123 which is situated at the outermost face of the outermost disc 117. The cam member 123 is not attached to the disc 117 or to the axle 119 but is held stationary. Each of the U-shaped article holding means 121 has a cam follower lever arm 125 attached thereto so that as the discs 117 rotate—i.e. the peeling mechanism 109 rotates—the cam follower lever arms 125 track the cam surface 123. This, in turn, causes the U-shaped article holding means 121 to swing to close against the article 113. It also allows the U-shaped article holding means 121 to be opened somewhat to allow for discharge. It can be seen by inspecting FIG. 11 that the direction of rotation of the peeling mechanism 109 is anticlockwise and that the U-shaped article holding means 121 at the 9:00 o'clock and 6:00 o'clock positions have opened relative to the U-shaped article holding means 121 at the 3:00 o'clock and 12 o'clock positions.

In order to effect peeling of the articles 113, the discs 117 carry cutting means in the form of cutting cylinders 127 (see FIG. 10) which are carried within cylindrical casings 131 attached to the innermost disc 117. The cutting cylinder 127 is of a diameter equal to that which is required of the article. In other words the cutting cylinders 127 are used for plunging sideways through the discs 117 to cut a cylindrical portion from the articles 113. The diameter of the cutting cylinders 127 is therefore chosen appropriately to provide the maximum effective diameter of cut whilst allowing the peel to be removed during the plunging operation of the cutting cylinders 127. It can be seen in FIG. 9 that each of the discs 117 has aligned openings 133 at the position of each of the U-shaped article holding means 121. The cutting cylinders 127 are caused to be displaced sideways to penetrate the article 113 by means of a guiding cam track 135 arranged on a cylindrical cam 137 which is mounted stationary relative to the axle 119. The cutting cylinders 127 connect with a finger 139 which locates in the guiding cam track 135. Thus, after an article 113 has been received in the U-shaped article holding means 121 and clamped by the arms thereof, as the discs 117 rotate the respective cutting cylinder 127 is then caused to be displaced sideways to penetrate the article 113 and cut a cylindrical portion or core therefrom. The article 113 is inhibited from being displaced sideways by locating against the inner wall face of the outermost disc 117. Thus, the required portion of the article 113 is received within the respective cutting cylinder 127, whilst the unwanted peel portion remains external of the cutting cylinders 127.

When the article 113 is peeled in this manner it will be appreciated that each of its side surfaces adjacent the respective discs 117 will still have a portion of the peel remaining.

The remaining peel on the wanted portion of the article 113 is then removed by the peel removing means in the form of the slicing mechanism 111. In order to allow the slicing mechanism 111 to slice the remaining end portions of the peel from the wanted portion of the article 113, the wanted portion of the article 113 within the cutting cylinders 127 is pushed through the opening 133 in the outermost disc 117 into U-shaped holding means 141. This occurs when the discs 117 are approximately at the 2:00 o'clock position during rotation of the discs 117. In order to effect such transfer into the U-shaped holding means 141 there is provided a moveable member in the form of a pushing plunger 143 in each of the cutting cylinders 127 (FIG. 10 clearly shows the arrangement). The pushing plunger 143 carries a finger 145 which locates in a second guiding cam track 147 on the cam cylinder 137. Each of the cutting cylinders 127 and the pushing plungers 143 can be suitably journalled within the cylindrical casing 131 to permit for free sliding movement into the extending and retracted positions relative to the casings 131. The relevant disc 117 performs the function of the peel removing member during this transfer.

The slicing mechanism 111 may comprise only two slicing discs for cutting the respective peel off the respective ends of the portion of the article which is to be peeled. In the embodiment shown herein, the slicing mechanism comprises a series of slicing discs for simultaneously cutting the article into disc-like portions. The slicing mechanism 111 comprises the cutting discs 149 which are driven by a motor 151. The slicing mechanism 111 can be swung upward and downwardly relative to the motor 151 as diagrammatically shown in FIG. 11. This swinging is to permit ease of cleaning of the machine. In normal use, the slicing mechanism 11 is mounted in the full-line position shown in FIG. 11. It can be seen that the U-shaped holding means 141 have a series of slits 153 therein. Each of the slicing discs 149 is aligned so that it will pass cleanly through the slits 153. In this manner the article can be cut into disc-like portions as the discs 117 rotate past the cutting discs 149.

As the sliced and peeled articles 113 move from the 9:00 o'clock position towards the 6:00 o'clock position, they fall from the U-shaped holding means 141 onto a conveyor 155 to be transferred to a suitable location. The ends of the cylindrical cut portions of the article 113 are deflected by fingers (not shown) so that they fall into a peel hopper 157. Finger means 159 (see FIG. 10) are provided at the 6:00 o'clock position of the discs 117 to pass through slots 161 in each of the U-shaped holding means 121 to remove the peel portion of the article 113 which may remain in the U-shaped article holding means 121. This clears the U-shaped article holding means 121 for receiving a fresh article 113 when that U-shaped article holding means 121 is at the bottom of the chute 115.

Oranges, for example, which may be a convenient article 113 to be peeled by the apparatus are usually graded into various sizes. Thus, the diameter of the cutting cylinders 127 will have to be of different diameters for different size grades of oranges. Accordingly, the cylindrical casing 131 together with the cutting cylinders 127 and pushing plungers 143 are removable from the innermost disc 117 by means of quick release means having quick release levers 163. Thus, an appropriate sized cylindrical casing 131, cutting cylinder 127 and pushing plungers 143 can be placed on the innermost disc 117.

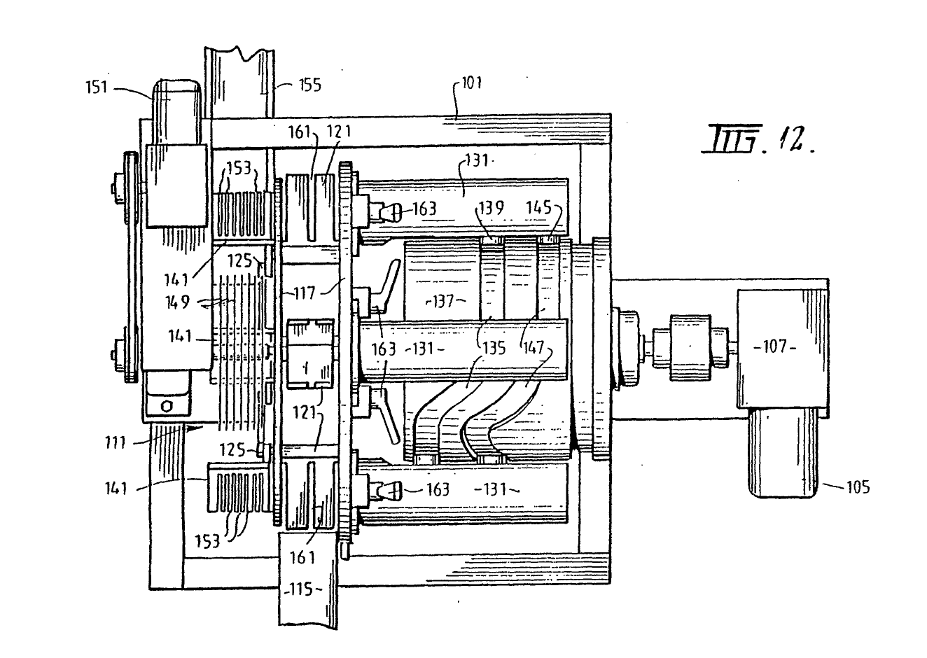

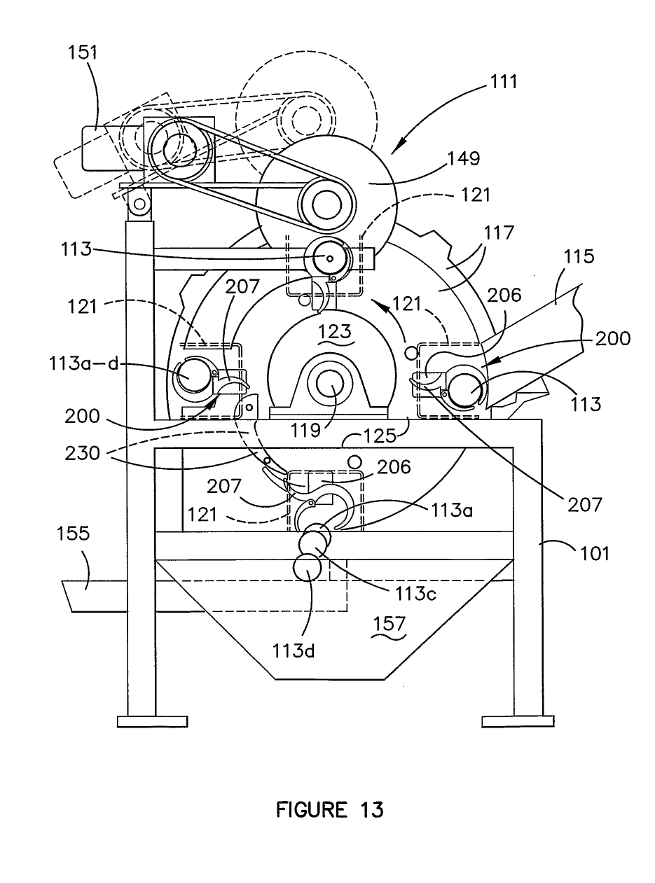

In FIG. 13, like reference numerals indicate like parts to those previously described and the apparatus works similar to that described with reference to FIGS. 1 and 12. However, in this embodiment, the holding means 141 are in the form of clamping members 200.

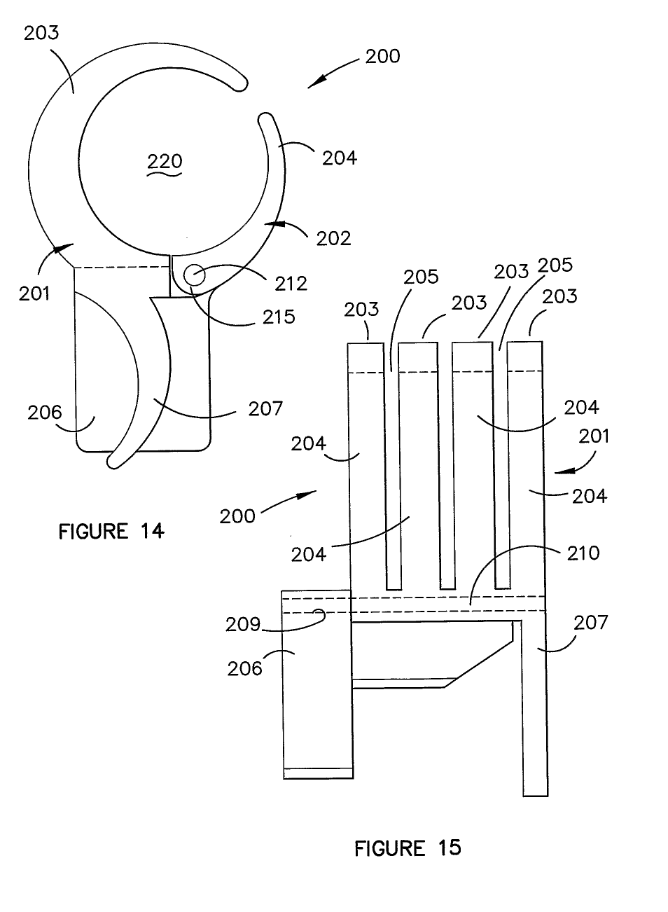

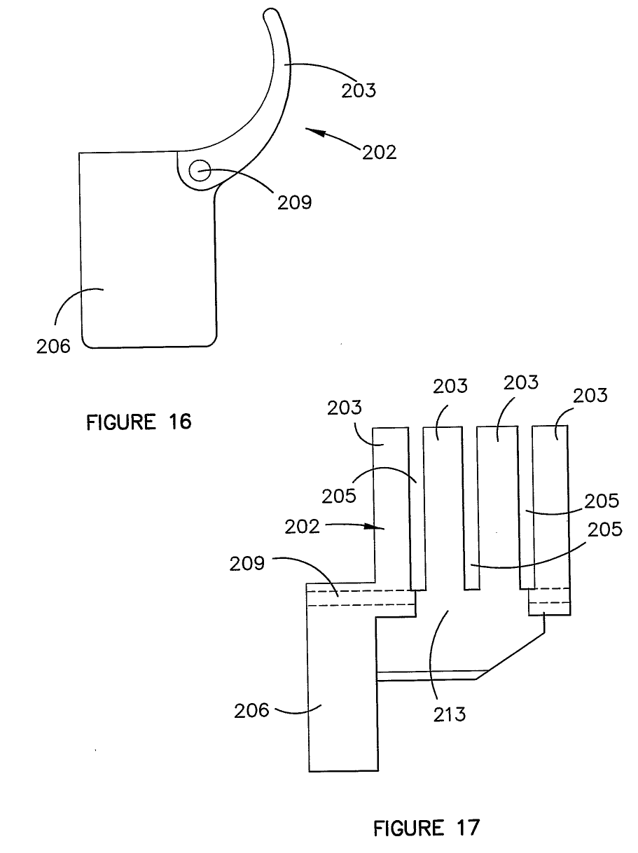

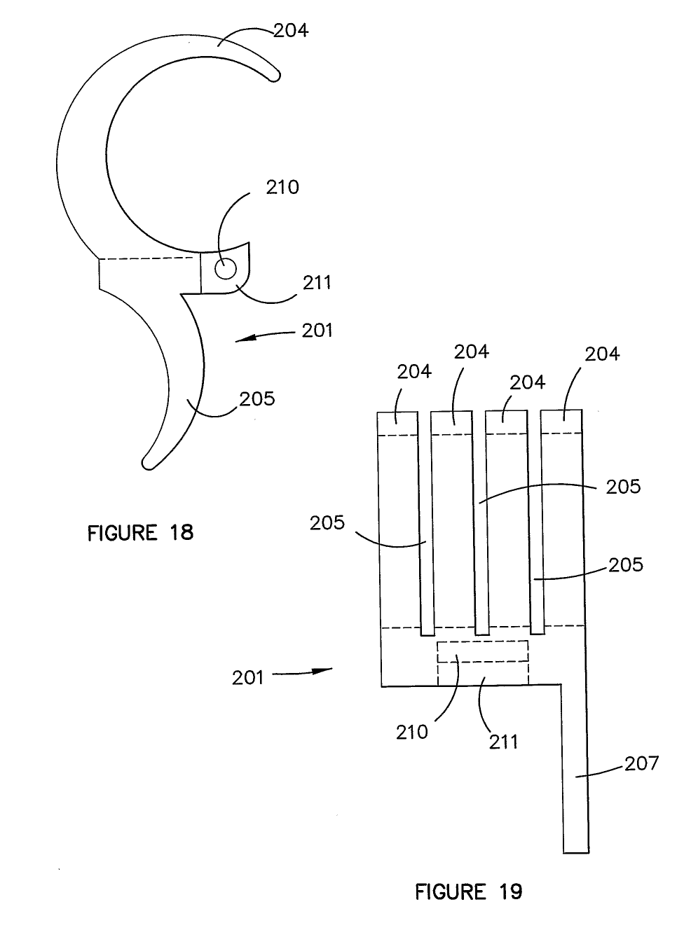

As shown in FIGS. 14 to 17, the clamping members 200 comprise a first component 201 and a second component 202. The component 201 has a plurality of curved fingers 203 which are spaced apart and an abutment tail 207. The component 202 has a plurality of curved fingers 204 which are also spaced apart and which register with the fingers 203 so as to define slots or spaces 205 (see FIG. 15). In the embodiment shown, each of the components has four fingers. The component 202 has a mounting block 206 which bolts on to disc 117 and is provided with a bore 209. The component 202 is also provided with a corresponding bore 210 and has a hinge-like fit with the component 201 so ridge 211 of component 202 fits into recess 213 of the component 201 and so the bores 209 and 210 are aligned and receive a pivot shaft 212 (FIG. 14). A spring 215 is wound about the shaft 212 so as to bias the fingers 203 and 204 into the position shown in FIG. 14, which is a clamping position.

Thus, the fingers 204 are moveable on the pivot pin 213 relative to the block 206 and the fingers 203. The clamping holders 200 register with the holes 133 in the same manner as the holders 141 and when a core of orange 113 is pushed through the hole 133 in the manner previously described, it is pushed into the closed and clamped holder 200. The pushing action may slightly spread the fingers 203 and 204 about the shaft 212 as the cored piece of fruit moves into the space 220 (see FIG. 14) defined by the respective fingers 203 and 204 of the clamping holder 200. Nevertheless, the cored piece of fruit will be firmly clamped and held in the holder 200 so that as the disc 117 rotates (in this embodiment, in an anti-clockwise direction) towards the slicing blades 149, the fruit is firmly and securely held for slicing. As the fruit reaches the slicing blade in the 12 o'clock position, as shown in FIG. 13, the slicing blades 149 will enter the spaces 205 and slice the fruit into four slices 113a-d. The blade can either be retained in the cutting position (which is the lowered position in FIG. 13) or can be retracted into the upper position shown in dotted lines in FIG. 13 between cutting operations. As the discs 117 continue to rotate, the tail 207 of the component 202 makes contact with cam 230 (at the 9 o'clock position in FIG. 13) so the continued rotation of the plate 117 will cause the cam 230 to push against the tail 207 and therefore pivot the component 201 relative to the component 202 on the shaft 212 against the bias of spring 215 to open the fingers 203 and 204 so that when the holder reaches the 6 o'clock position shown in FIG. 13, the clamping holder 200 is completely open and the sliced fruit can drop on to a conveyor table for conveying to a packing station or the like. As soon as the tail 207 leaves the cam 230, the spring 215 biases the fingers 203 and 204 back into the closed and clamping position shown in FIG. 13 (at the 3 o'clock, 12 o'clock and 9 o'clock positions in FIG. 13).

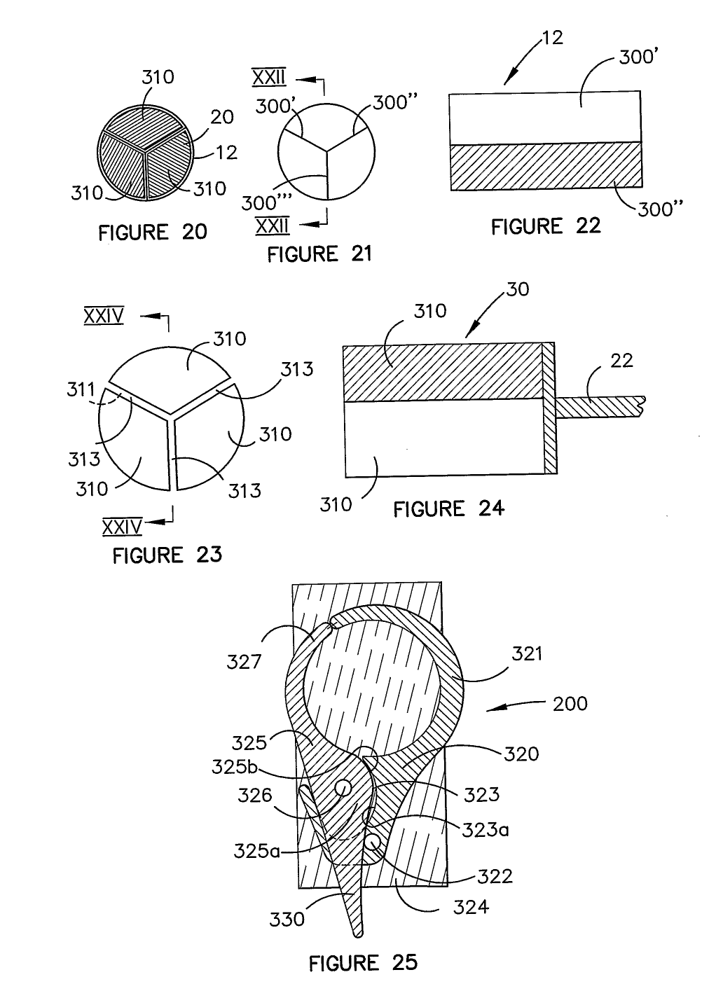

FIG. 20 to FIG. 24 are drawings of a corer and plunger according to a second embodiment of the invention. Like reference numerals indicate like parts to those described with reference to FIGS. 1 to 8. For ease of illustration, the upright members 18 and ring 16 are not shown. The corer of FIG. 20 comprises the cutting cylinder 12 and plunger 20. The cutting cylinder 12, as best shown in FIG. 21, is provided with a plurality of internal segmenting blades 300 (300′, 300″, 300′″). In the embodiment of FIG. 21 three such blades are shown to segment the article. This embodiment has particular application to mandarins and for segmenting the mandarins as well as slicing the mandarins into slices so that segmented slices (i.e. small blocks) of mandarin are provided. In FIG. 22, the segmented blades labeled 300′ and 300″ are shown.

The plunger 12 is formed from three separated arcuate segments 310 which are connected together by a rear plate 311 (see FIG. 24). The segments 300 are separated from one another, as is most apparent in FIGS. 20 and 23, so that when the plunger 20 is moved into the cylinder 12, the spaces 313 between the segments accommodate the cutting blades 300 so the plunger 20 can push the segmented core out of the cylinder 12 into one of the clamping members 200.

FIG. 25 shows a second embodiment of a clamping member 200. The embodiment of FIG. 25 has the advantage that no springs are used which improves the ability to clean the device and prevents the possibility of build-up of organic material within the springs. The clamping member 200 of FIG. 25 is positively moved into the clamping position and release position and does not require spring biasing either in the clamping mechanism itself or in the support mechanism or cam mechanism used to open and close the clamping member 200.

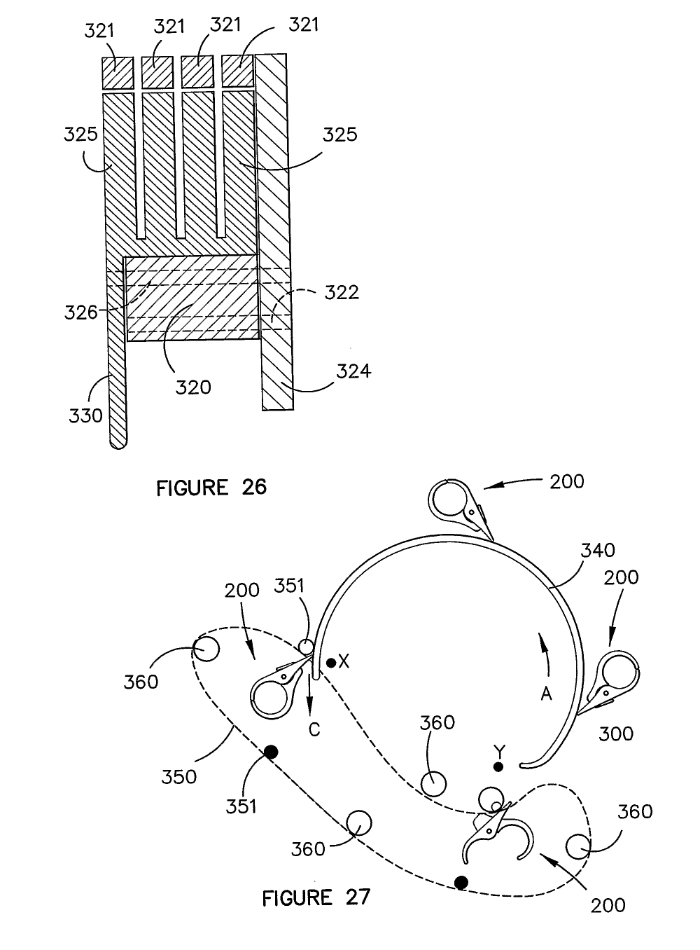

With reference to FIGS. 25 and 26, the clamp member 200 has a first component 320 which has a plurality of curved fingers 321. The first component 320 includes a curved recess 323. The first component 320 is mounted on a pivot pin 322 which is fixed to a mounting block 324 which mounts on the apparatus in the same manner as the block 106 previously described.

The member 200 also has a second component 325 which is mounted on a pivot pin 326 also journalled in block 324. The second component 325 has a plurality of fingers 327. As in the previous embodiments, the fingers 321 and 327 are spaced apart and register with one another, as is best shown in FIG. 26.

The second component 325 has a boss section 325a which locates in the recess 322. When the second component 325 rotates on pivot pin 326 to the open position, a cam surface 325b on the boss 325a contacts surface 323a of the recess 322 to slightly rotate the first component 320 on pivot pin 323.

The second component 325 is provided with an abutment tail 330. When a core is cut, the core locates in the holder 200 of FIGS. 25 and 26 in the same manner as in the embodiments previously described. The core is securely held within the fingers 321 and 327.

As is best shown in FIG. 27, the holders 200 move relative to a cam 340 which engages abutment 330 which positively pushes the components 320 and 325 into the closed clamping position shown in FIG. 25. The cam 340 runs for approximately 270° so that the holder 200 is maintained closed as in the earlier embodiment (i.e. from the 6 o'clock position to the 9 o'clock position in an anti-clockwise direction). No springs are required to bias the holder into the closed position and the holder 200 is forced into the closed position positively by engagement of the abutment tail 300 on the cam 340. A second cam member 350 is provided which is moveable relative to the holders 200. The cam 350 has cam lugs 351. As the cam 350 moves, one of the lugs 351 catches up to the abutment tail 300 and pushes the abutment tail in the direction of arrow C in FIG. 27. This pushes the holder into the open position, so that as the holder continues its movement from point X to point Y, the holder is opened to release the sliced article so the sliced article can be dropped onto conveyor 155 (not shown in FIG. 27).

The cam 350 may be guided around rollers 360, one of which may be driven to move the cam 350 and lugs 351 relative to the holders 200 to facilitate opening of the holders.

Other forms of mechanisms can be utilized to positively hold the holders 200 in the closed position and then positively open the holders for release of the sliced article.

In this embodiment of the invention, the mechanisms do not involve springs which is preferable when handling food items to prevent the build-up of organic material which may locate in the springs and not be easily cleaned and which may then form a contaminant which can spoil the sliced food product.

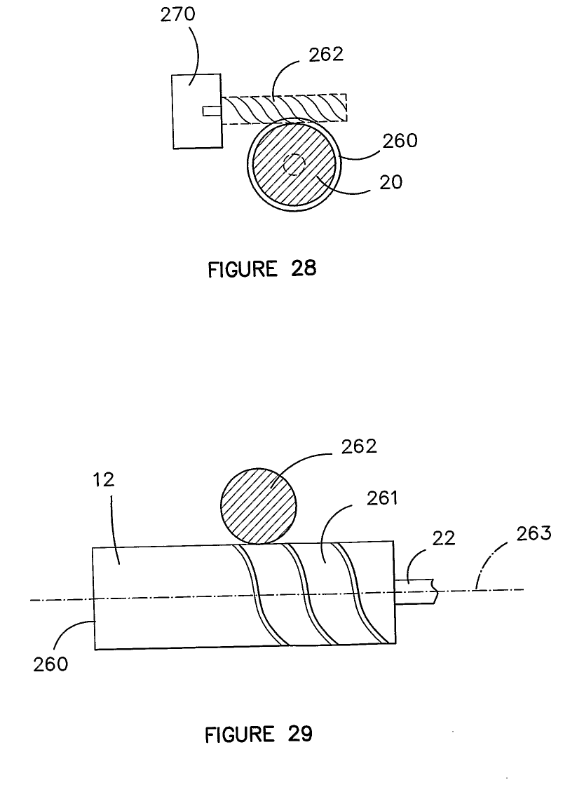

FIGS. 28 and 29 show a still further embodiment of the invention in which the cylinder 12 is rotated as it cuts the core from the article. The rotating of the cylinder 12 facilitates cutting and reduces blunting of the cutting edge of the cylinder 12. That is, by rotating the cylinder 12, the cutting edge 260 shown in FIGS. 28 and 29 tends to cut more like a knife to slice into the article to cut the core, rather than simply being pushed forward into the article, as in the earlier embodiments.

The cylinder 12 is provided with a helical gear track 261 and worm drive 262 engages the track 261 to rotate the cylinder 12. The worm drive 262 may be controlled by a controller 270 in synchronism with movement of the corer 12 into the cutting position to cut the core.

In this embodiment the cylinder 12 is mounted independently of the plunger 20 so it can be easily rotated. In this regard, the member 12 may be supported in its own bearings (not shown) to facilitate rotary movement of the corer 260 about its central axis 263 and also linear movement into the article to cut the core. The plunger 20 may be fixed against rotation so that it does not rotate with the cylinder 12, but merely pushes into the cylinder as in the earlier embodiments to push the core from the cylinder 12 after the core has been cut.

However, if the corer is provided with the segmenting blades 300, then both the plunger 20 and cylinder 12 will need to rotate together to facilitate rotation of the blade 300 with the cylinder 12 and the linear movement of the plunger 20 to remove the core.

The apparatus according to the preferred embodiments of the invention may be formed from any suitable materials. Most preferably the components which are involved in the handling and slicing of food products are formed from food grade stainless steel. However, in other embodiments, the components may be formed from suitable plastic material or other suitable material.

Since modification within the spirit and scope of the invention may readily be effected by persons skilled within the art, it is to be understood that this invention is not limited to the particular embodiments described by way of example hereinabove.

In the claims which follow and in the preceding description of the invention, except where the context requires otherwise due to express language or necessary implication, the word “comprise”, or variations such as “comprises” or “comprising”, is used in an inclusive sense, i.e. to specify the presence of the stated features but not to preclude the presence or addition of further features in various embodiments of the invention.

It is to be understood that the prior art publications referred to herein, do not constitute an admission that that the publication forms a part of the common general knowledge in the art, in Australia or in any other country.

1. A peeler and slicer apparatus for slicing an article, comprising:
a corer for receiving the article and for cutting a core from the article to thereby remove a peripheral layer of peel from about the article;
a holder having a first component and a second component which are relatively moveable into a clamping position so the core is clampable in the holder, and a release position so that the core is releasable from the holder, the holder having a plurality of spaces; and
a slicer having a plurality of slicing blades for entering the spaces and slicing the core to thereby slice the article into a plurality of sliced pieces when the holder is in the clamping position.

2. The apparatus of claim 1 wherein the first component of the holder comprises a plurality of spaced apart fingers, the second component comprising a plurality of spaced apart fingers which register with the spaced apart fingers of the first component, a hinge for coupling the first component to the second component, and a spring for biasing the first component into a clamping position relative to the second component.

3. The apparatus of claim 2 wherein the second component comprises an abutment and the apparatus includes a cam so that after the article has been sliced, the abutment engages the cam to force the first component away from the second component against the bias of the spring to thereby release the sliced article from the holder.

4. The apparatus of claim 1 wherein the corer comprises a cutting member, a movable member arranged for relative movement into said cutting member and a peel removing member, wherein said cutting member is adapted to cut into an article to be peeled so that at least a portion of said article is received within said cutting member with the peel surrounding the cutting member, said peel removing member is adapted to move relative to said cutting member to push the peel away from the cutting member and said movable member being movable relative to said cutting member into said cutting member so that said portion of the article can be pushed out of said cutting member.

5. The apparatus of claim 4 wherein said cutting member comprises a cylinder and said movable member comprises a plunger arranged within a top portion of said cylinder and movable relative to said cylinder so as to push said portion of the article out of said cylinder after it is cut.

6. The apparatus of claim 4 wherein said peel removing member comprises a ring member which surrounds the cutting cylinder and is movable relative to the cutting cylinder so as to push the peel away from the cutting cylinder.

7. The apparatus of claim 1 wherein the first component of the holder comprises a plurality of spaced apart fingers, the second component comprises a plurality of spaced apart fingers which register with the spaced apart fingers of the first component, a first pivot pin for pivotally coupling the first component for pivotal movement relative to the second component, and the apparatus further comprising a mechanism for positively forcing the first component and second component into the clamping position and for positively moving the first component relative to the second component to the release position.

8. The apparatus of claim 7 wherein the mechanism comprises a cam track for engaging an abutment on one of the first and second components for pivoting the first component relative to the second component into the clamping position, and a second cam component for engaging the abutment to pivot the second component relative to the first component so that the first component and second component are moved to the release position.

9. The apparatus of claim 8 wherein the holder has a second pivot pin for pivotally coupling the first component relative to the device and the second component includes a cam surface so when the first and second components move about the first pivot pin, the cam surface of the second component engages the first component to cause pivotal movement of the second component about the second pivot pin to facilitate opening of the holder into the release position.

10. The apparatus of claim 1 wherein the corer includes a rotating mechanism for rotating the corer as the corer cuts the article to facilitate cutting of the article by the corer.

11. The apparatus of claim 10 wherein the mechanism may comprise a worm drive for engaging a cooperating track on the corer for rotating the corer.

12. The apparatus of claim 4 wherein the corer has a plurality of internal segmenting blades so that when the corer cuts a core from the article, the core is also cut into a plurality of segments.

13. The apparatus of claim 12 wherein the moveable member comprises a plurality of separated segments for moving over the slicing blades when the moveable member moves relative to the corer to enable the moveable member to move into the corer to push the core from the corer.

14. A peeler and slicing apparatus comprising a cutting member, a movable member arranged for relative movement into said cutting member and a peel removing member, wherein said cutting member is adapted to cut into an article to be peeled so that at least a portion of said article is received within said cutting member with the peel surrounding the cutting member, said peel removing member is adapted to move relative to said cutting member to push the peel away from the cutting member and said movable member being movable relative to said cutting member into said cutting member so that said portion of the article can be pushed out of said cutting member, said cutting member comprising a cylinder and said movable member comprising a plunger arranged to relatively move within a portion of said cylinder to push said portion of the article out of said cylinder after it is cut, and wherein there is provided a pair of discs axially mounted on an axle in spaced apart relation, the spacing being sufficient to allow an article to be peeled to be placed therebetween, article holding means between the discs for supporting the article to be peeled relative to the pair of discs, openings in said pair of discs angularly aligned with each other at the position of said article holding means, said cutting member and said movable member being alignable with said openings, the opening in one of said pair of discs being of a size sufficient to allow both said cutting member and said movable member to pass therethrough, and the opening in the other of said pair of discs being of size to allow the portion of said article to pass therethrough, said pair of discs being axially rotatable with said axle so that when an article is received in said article holding means, said cutting member can extend to pass through the opening in said one of said pairs of discs so said portion will be within said cutting member and said movable member can then extend to pass through said opening to push said portion through the opening in the other of said pairs of discs, and a gripping and holding mechanism having a first component and a second component, each component having a plurality of spaced apart fingers, the first and second components being mounted for relative movement with respect to one another from a clamping position to an open position, so that the portion can be held in the holding and clamping mechanism in a clamped position, and slicing means for slicing the portion through the spaces between the fingers so as to slice the portion into a plurality of sections.

15. The apparatus of claim 14 wherein said peel removing member comprises a ring member which surrounds the cutting cylinder and is movable relative to the cutting cylinder so as to push the peel away from the cutting cylinder.

16. The apparatus of claim 14 wherein there is also provided peel removing means for removing the peel from the ends of said portion of the article.

17. The apparatus of claim 14 wherein said cutting member and said movable member are mounted to said one of said pairs of discs so they rotate with said pairs of discs and wherein said cutting member and said movable member are connected with cam means to effect extension and retraction relative to said pairs of discs so said portion can be cut and received within said cutting member and so said portion can be pushed from said cutting member as the pair of discs rotate and so said cutting member and said movable member can be retracted to allow removal of peel cut from said article and to allow the introduction of another article to said holding means.

18. The apparatus of claim 17 wherein said cam means is mounted co-axially of said axle so that as said pair of discs rotate there will be relative angular movement relative to said cam means whereby said cutting member and said movable member can be extended and retracted.

19. The apparatus of claim 17 wherein there are two cam tracks forming part of said cam means, one track being for a cam follower which connects with said cutting member and the other track being for a cam follower which connects with said pushing member.

20. The apparatus of claim 14 wherein there are a plurality of angularly spaced cutting members and related movable members mounted relative to said pair of spaced discs, each similarly adapted, in turn, to effect peeling of a respective article as said pair of spaced discs is rotated.

21. The apparatus of claim 14 wherein said holding means is movable to clampingly engage with an article during peeling.

22. The apparatus of claim 14 wherein said holding means comprises a pair of swinging arms which can swing to open and close the holding means to release and to hold an article therein, and further cam means to effect such opening and closing as said pair of discs rotate.

23. The apparatus of claim 14 wherein said peel removing means is mounted to swing from a cutting position to permit ease of cleaning of said peeler.

24. The apparatus of claim 14 wherein there is provided article delivery means for delivering an article to said holding means as said holding means rotates therepast.

25. The apparatus of claim 14 further comprising the peeler includes a discharge conveyor for receiving peeled articles as they are discharged from said further holding means as said further moulding means rotates therepast.

26. The apparatus of claim 14 further comprising the peeler includes peel receiving means for receiving peel cut from said article as said pair of discs is rotated.

27. The apparatus of claim 14 wherein said cutting members and said movable members are attached to said pair of discs by quick release means so they can be changed to different sizes to effect efficient peeling of different sized articles.

28. The apparatus of claim 14 wherein the first and second components are mounted by a pivot pin and a biasing means for spring biasing the first and second components into the clamping position.

29. The apparatus of claim 14 wherein the first component of the holder comprises a plurality of spaced apart fingers, the second component comprises a plurality of spaced apart fingers which register with the spaced apart fingers of the first component, a first pivot pin for pivotally mounting the first component relative to the second component, and the apparatus further comprising a mechanism for positively forcing the first component and second component into the clamping position and for then positively moving the first component relative to the second component to the release position.

30. The apparatus of claim 29 wherein the mechanism comprises a cam track for engaging an abutment on one of the first and second components for pivoting the first component relative to the second component into the clamping position, and a cam component for engaging the abutment to pivot the second component relative to the first component so that the first component and second component are moved to the release position.

31. The apparatus of claim 30 wherein the holder has a second pivot pin for pivotally coupling the first component relative to the device and the second component includes a cam surface so when the first and second components move about the first pivot pin, the cam surface of the second component engages the first component to cause pivotal movement of the second component about the second pivot pin to facilitate opening of the holder into the release position.

32. The apparatus of claim 14 wherein the corer includes a rotating mechanism for rotating the corer as the corer cuts the article to facilitate cutting of the article by the corer.

33. The apparatus of claim 32 wherein the mechanism may comprise a worm drive for engaging a cooperating track on the corer for rotating the corer.

34. The apparatus of claim 14 wherein the corer has a plurality of internal segmenting blades so that when the corer cuts a core from the article, the core is also cut into a plurality of segments.

35. The apparatus of claim 14 wherein the moveable member comprises a plurality of separated segments for moving over the slicing blades when the moveable member moves relative to the corer to enable the moveable member to move into the corer to push the core from the corer.

36. A peeler and slicer apparatus for slicing an article, comprising:
a corer having a peripheral cutting edge and at least one internal cutting blade;
a holder for holding the article;
a moving mechanism for moving the corer relative to the holder so that the peripheral cutting edge cuts a core from the article to thereby remove a peripheral layer of peel from about the article and the internal cutting blade cuts the core into at least two segments; and
a push member for movement relative to the corer for pushing the core from the corer.

37. The apparatus of claim 36 wherein the apparatus further comprises a slicer having a plurality of slicing blades, the holder having a plurality of spaces, and the slicer being moveable relative to the holder so that the slicing blades are able to enter the spaces and slice the core to thereby slice the segmented core into a plurality of sliced and segmented pieces.

38. The apparatus of claim 36 wherein the holder has a first component and a second component, the first component of the holder comprises a plurality of spaced apart fingers, the second component comprising a plurality of spaced apart fingers which register with the spaced apart fingers of the first component, a hinge for coupling the first component to the second component, and a spring for biasing the first component into a clamping position relative to the second component.

39. The apparatus of claim 38 wherein the second component comprises an abutment and the apparatus includes a cam so that after the article has been sliced, the abutment engages the cam to force the first component away from the second component against the bias of the spring to thereby release the sliced article from the holder.

40. The apparatus of claim 36 wherein the holder has a first component and a second component, the first component of the holder comprises a plurality of spaced apart fingers, the second component comprises a plurality of spaced apart fingers which register with the spaced apart fingers of the first component, a first pivot pin for pivotally mounting the first component relative to the second component, and the apparatus further comprising a mechanism for positively forcing the first component and second component into the clamping position and then for positively moving the first component relative to the second component to the release position.

41. The apparatus of claim 40 wherein the mechanism comprises a cam track for engaging an abutment on one of the first and second components for pivoting the first component relative to the second component into the clamping position, and a cam component for engaging the abutment to pivot the second component relative to the first component so that the first component and second component are moved to the release position.

42. The apparatus of claim 41 wherein the holder has a second pivot pin for pivotally coupling the first component relative to the device and the second component includes a cam surface so when the first and second components move about the first pivot pin, the cam surface of the second component engages the first component to cause pivotal movement of the second component about the second pivot pin to facilitate opening of the holder into the release position.

43. The apparatus of claim 38 wherein the corer includes a rotating mechanism for rotating the corer as the corer cuts the article to facilitate cutting of the article by the corer.

44. The apparatus of claim 43 wherein the mechanism may comprise a worm drive for engaging a cooperating track on the corer for rotating the corer.

45. A peeler and slicer apparatus for slicing an article, comprising:
a corer for receiving the article and for cutting a core from the article to thereby remove a peripheral layer of peel from about the article;
a holder for holding the article;
a moving mechanism for moving the corer relative to the holder; and
a core rotating member for rotating the core so that as the corer cuts into the article, rotation of the corer facilitates the cutting action to remove the peripheral layer of peel and produce the core from the article.

46. The apparatus of claim 45 wherein the holder has a plurality of spaces and the apparatus further comprises a slicer having a plurality of slicing blades for entering the spaces and slicing the core to thereby slice the article into a plurality of sliced pieces.

47. The apparatus of claim 46 wherein the holder has a first component and a second component which are relatively moveable into a clamping position so the core is clamped in the holder and a release position so the core is releasable from the holder.

48. The apparatus of claim 46 wherein the first component of the holder comprises a plurality of spaced apart fingers, the second component comprising a plurality of spaced apart fingers which register with the spaced apart fingers of the first component, a hinge for coupling the first component to the second component, and a spring for biasing the first component into a clamping position relative to the second component.

49. The apparatus of claim 48 wherein the second component comprises an abutment and the apparatus includes a cam so that after the article has been sliced, the abutment engages the cam to force the first component away from the second component against the bias of the spring to thereby release the sliced article from the holder.

50. The apparatus of claim 46 wherein the first component of the holder comprises a plurality of spaced apart fingers, the second component comprises a plurality of spaced apart fingers which register with the spaced apart fingers of the first component, a first pivot pin for pivotally coupling the first component to the second component, and the apparatus further comprising a mechanism for positively forcing the first component and second component into the clamping position and then for positively moving the first component relative to the second component to the release position.

51. The apparatus of claim 50 wherein the mechanism comprises a cam track for engaging an abutment on one of the first and second components for pivoting the first component relative to the second component into the clamping position, and a cam component for engaging the abutment to pivot the second component relative to the first component so that the first component and second component are moved to the release position.

52. The apparatus of claim 51 wherein the holder has a second pivot pin for pivotally coupling the first component relative to the device and the second component includes a cam surface so when the first and second components move about the first pivot pin, the cam surface of the second component engages the first component to cause pivotal movement of the second component about the second pivot pin to facilitate opening of the holder into the release position.

53. The apparatus of claim 45 wherein the member comprises a worm drive for engaging a cooperating track on the corer for rotating the corer.

54. The apparatus of claim 45 wherein the corer has a plurality of internal segmenting blades so that when the corer cuts a core from the article, the core is also cut into a plurality of segments.

55. The apparatus of claim 54 wherein the apparatus further comprises a moveable member having a plurality of separated segments for moving over the slicing blades when the moveable member moves relative to the corer to enable the moveable member to move into the corer to push the core from the corer.
